(19) United States
(12) Patent Application Publication
(10) Pub. No.: US 2002/0099533 A1
(43) Pub. Date: Jul. 25, 2002

(54) Data processing system for searching and communication

(76) Inventor: Evan Jaqua, Seattle, WA (US)

Correspondence Address: Chernoff, Vilhauer, McClung & Stenzel, LLP, 1600 ODS Tower, 601 S.W. Second Avenue, Portland, OR, 97204, US

(21) Appl. No.: 09/768,989

(22) Filed: Jan. 23, 2001

(51) Int. Cl. G06F 17/20

(52) U.S. Cl. 704/1

(57) ABSTRACT

A data processing system that facilitates searching and communicating in a multilingual environment is disclosed. Entities registering with the system in a first language can be identified by searchers searching in a different language. To facilitate communication, a message can be composed in one language can be delivered to a recipient in another language.

### CROSS-REFERENCE TO RELATED APPLICATIONS

Not applicable.

### BACKGROUND OF THE INVENTION

The present invention relates to a data processing system and, more particularly, to a data processing system useful for locating entities of interest in a multilingual environment and facilitating communication between entities that do not share a common language.

The Internet is a global association of data networks and computers loosely connected to share information using a common protocol. The World Wide Web (the “web”) is a subset of the Internet comprising a collection of Internet servers that support hypertext to interlink data files or “pages.” Individuals, businesses, organizations, or other entities commonly link together collections of web pages addressing related subjects to form web sites. The pages are written in the HyperText Markup Language (HTML) that tells a web browser program how to display the page on a data processing device connected to the web. In addition, the web facilitates information sharing and communication by its support of Internet protocols such as e-mail, File Transfer Protocol (FTP) and Telnet. The Internet defines a complex virtual web of connections accessible to persons located almost anywhere on the planet. Businesses seeking to be locatable and accessible to potential customers, suppliers, and investors in a global economy are particularly interested in the Web's potential for global information sharing and communication.

However, as is the case with most international activity, the potential of the Internet has been impeded by language. The typical method of locating resources with the Internet is a word search. If the seekers and the sought do not share a common language a word search is problematic. For example, it can be difficult and expensive for a Japanese business to develop mirror web sites in English and Spanish so that the business will be visible to English and Spanish speakers searching for a supplier of certain goods or services. In addition to differences in natural language, the specialized language used in many activities, such as the business terminology or jargon of a particular industry, makes translation even more expensive and difficult. Unless the context of a word's use is considered, literal translation of natural language words can often produce bizarre results. For example, “channel bank” is an American English term for a multiplexer used in the communications industry. Unless the translator is familiar with the particular industry and its terminology, a translation might imply the edge of a river or a financial institution. The reliability and relevance of a word search are limited by accuracy and relevance of the translation.

Resources are located by searching data bases indexing keywords or descriptors and network addresses. There are generally two types of address database systems; search engines and directories. Typically, a search engine utilizes a program known as a spider to robotically search the network and retrieve copies of files which are processed by an indexer to obtain descriptors and addresses that are added to the database. Familiar search engines such as www.Yahoo.com and www.excite.com focus on a broad range of subjects likely to be of interest to the substantial numbers of individuals accessing the web. While searching can be performed with queries containing Boolean expressions or other advanced processes, these search engines are not designed to search sites using multiple languages or to translate the search results to a language used by the searcher. Search engines typically do not recognize the specialized terminology, within a natural language, that may be used by specific industries or other groups engaged in a particular activity.

A directory's data base is created by manually indexing a page's address or uniform resource locator (url) and other information. Global trade portals and international trade marketplaces are sites offering information, searching, links, news and services to persons engaged in international trade. For example, the Global Information Network (www.ginfo.net) provides international trade related business news, reference information, and resource guides. These sites are typically directories of registering participants. While directories of international registrants can be searched at these sites, the sites do not provide for native language registration, multilingual searching, and translation of search results into a native language useful to the searcher. Further, these sites do not provide tools enabling communication between parties that do not share a common language.

What is desired, therefore, is a system and method for locating resources and communicating with a data processing network that avoids barriers created by language.

### BRIEF DESCRIPTION OF THE DRAWINGS

FIG. 1 is a schematic drawing of a data network.

FIG. 2 is a block diagram of the data processing system of the present invention.

FIG. 3 is a flow diagram of a registration method for the data processing system of the present invention.

FIG. 4A is an illustration of an exemplary English language registration form used in registering with the data processing system.

FIG. 4B is an illustration of a second page of the exemplary English language registration form of FIG. 4A.

FIG. 4C is an illustration of a third page of the exemplary English language registration form of FIG. 4A.

FIG. 4D is an illustration of a fourth page of the exemplary English language registration form of FIG. 4A.

FIG. 5 is a textual representation of an exemplary display and translation table for an information technology industry.

FIG. 6 is a flow diagram of a search by the data processing system.

FIG. 7 is an illustration of an exemplary English language search input form for the data processing system.

FIG. 8 is an illustration of an exemplary English language search result report for the data processing system.

FIG. 9 is a flow diagram of a communication process for the data processing system of the present invention.

FIG. 10A is an illustration of an exemplary English language message input display used when communicating through the data processing system.

FIG. 10B is an illustration of a second page of the exemplary English language message input display of FIG. 10A.

### DETAILED DESCRIPTION OF THE INVENTION

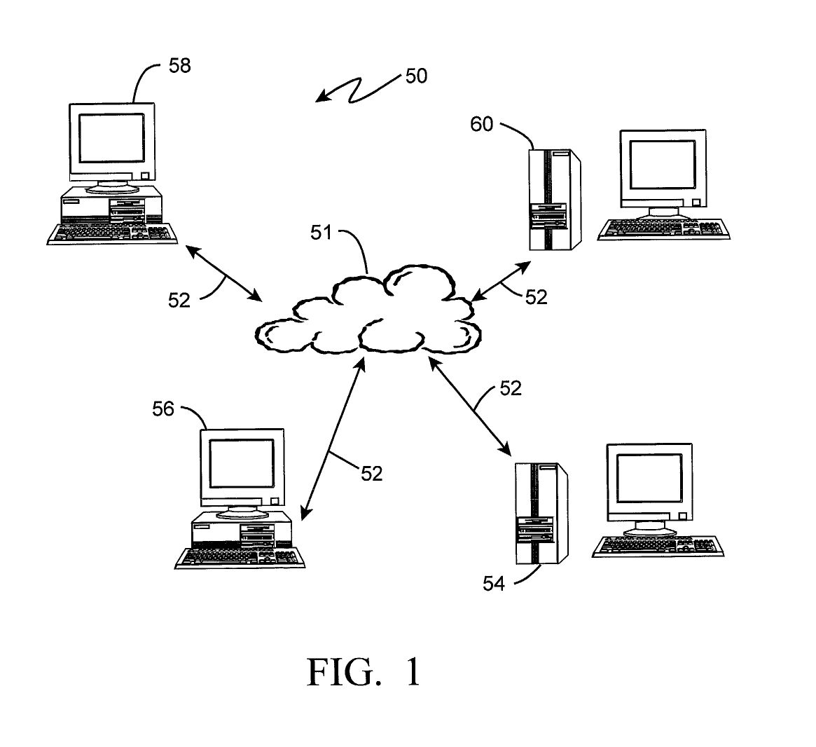

Referring to FIG. 1, the Internet 50 is a global association of data networks and computers loosely connected to share information using a common protocol. The World Wide Web (the “Web”) is a subset of the Internet comprising a collection of Internet servers that support several Internet protocols on a single interface. Internet protocols accessible from the Web include e-mail, FTP, Telnet, and Usenet News. In addition, the Web supports the HyperText Transfer Protocol (HTTP) permitting interlinking of data files or documents, commonly referred to as “web pages.” Web pages are written in the Hypertext Markup Language (HTML) that tells a Web browser program how to display the elements of the page on a user's data processing device. Related web pages are often linked to make up a web “site” which is typically managed by an individual, business, organization, or other entity having an interest in the subject of the related web pages. The Internet and the Web (hereinafter referred collectively as the Internet) define a complex virtual web of connections 51 to a vast number of documents and related graphical, audio, and video elements that can be readily displayed on data processing devices, for example computers 54, 56, 58, and 60, that may be located throughout the world and connected to the network by communication links 52.

The global nature of the Internet means that an entity can sponsor and manage a web site on a remotely located web server 60 from a local data processing device 54. Persons interested in the web site may access the web site from other data processing devices 56 and 58 that are connected to the network 50. While the Internet provides an infrastructure enabling global communication and information sharing, the likelihood that the potentially interested parties lack a common natural language remains a substantial obstacle to the Internet's usefulness for these purposes. The lack of a common language can be an even more significant problem if the parties wish to communicate concerning subjects which are described by a specialized language, such as the business terminology or jargon of a particular industry or other activity. The present inventor realized that the potential of the Internet to serve international activities could be more fully realized by facilitating information sharing and communication between entities that do not share a common language.

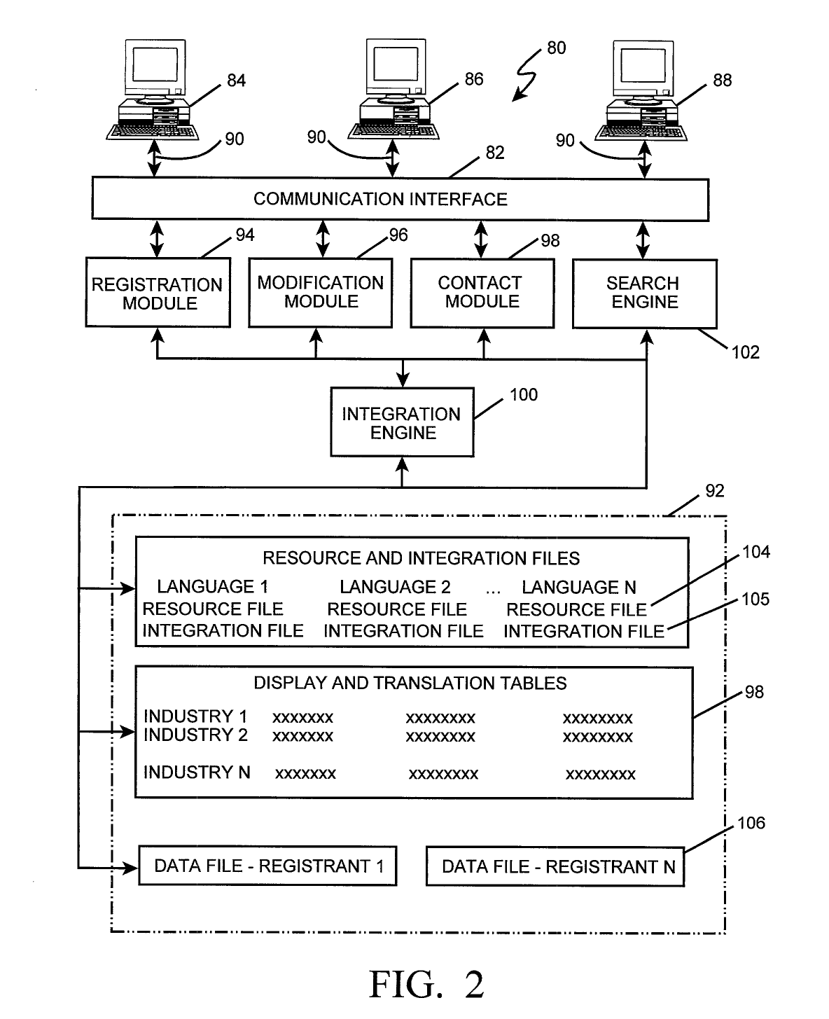

Referring to FIG. 2, the system 80 of the present invention is typically implemented as a web site. A communication interface 82 facilitates communication with users utilizing data processing devices 84, 86, and 88, typically connected to the interface by communication links 90 created in a data processing network such as the Internet. Generally, the system 80 comprises a data base 92, a registration module 94, a modification module 96, a contact module 98, an integration engine 100, and a search engine 102. The system 80 is modular in nature and may be installed on one or more data processing devices. The system 80 facilitates registration and related activities in a chosen language of the registrant, searching with queries and results in a chosen language of the searcher, and communication between users in their individual languages of choice. For example, a user seeking information about a business providing a certain type of product or service can query the data base in English and obtain information in English about a company that has registered in Japanese as a supplier of the product or service of interest. Further, since the specialized terminology used to describe the products and services in the language of the registrant (Japanese) is translated to the appropriate specialized terms in the other languages supported by the system, a word search in English produces very relevant and meaningful results. In addition, if the searcher is interested in further information about the registrant or its products or services, the searcher can send a message composed in English that will be received in Japanese by the registrant. Further, the system 80 provides a platform for accessing services supplementing the system permitting users to target resources to specific goals and budgets. While the system 80 is described herein by way of an exemplary business method and application, the system of the present invention is useful for other activities involving searching for resources and information and communicating using a data processing network serving a multilingual global culture.

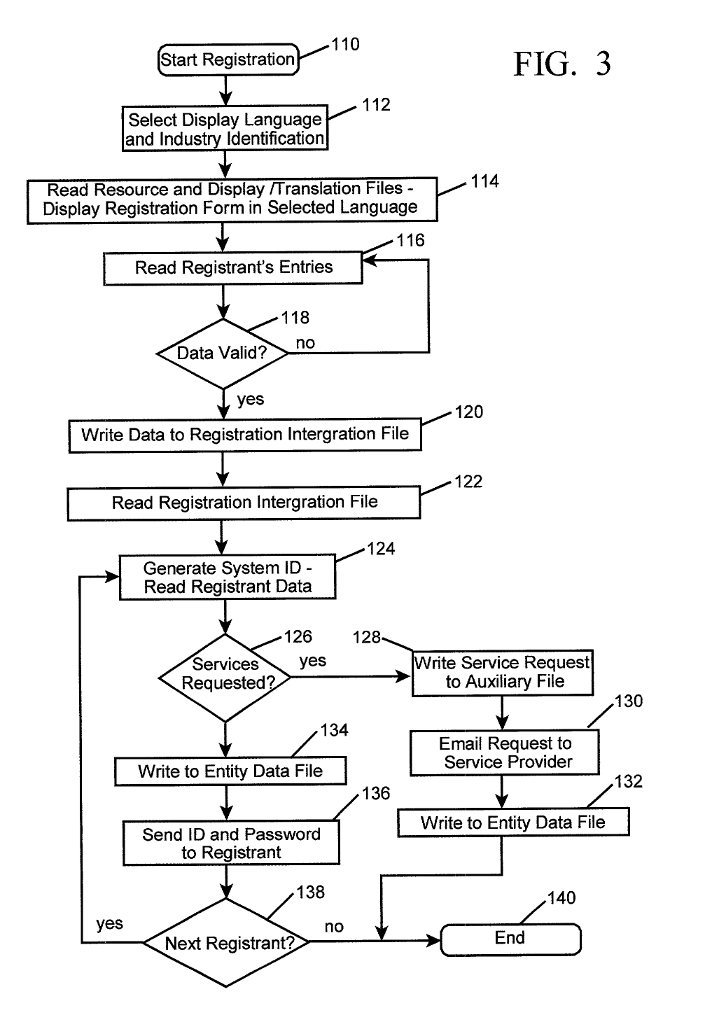

The data base 92 includes a directory of resources (for example companies, products, and services) registered with the system. Referring to FIG. 3, to register an entity with the system, a potential registrant 84 contacts the system through the communication interface 82 and initiates the registration process 110. The registration module 94 generates a registration form as the user interface to be displayed on the registrant's data processing device 84 during the registration process. The system generates the registration form in a supported natural language selected by the registrant 112. In addition to the selection of a language for the registration, the system provides for selection of a relevant activity, such as an industry, directing the system to use terminology more appropriate to that activity instead of more generalized natural language terms. For example in registering a business with the system, the registration form displays the particular names of the products and services used in the industry in which the business operates. The registrant is directed to associate products and services having these names with the registering business because persons seeking these products and services will use the appropriate industry specific term in their own native language. In other words, the terminology used by the system to describe characteristics associated with registering entities and to describe the subject of searches may be a specialized language within the natural languages supported by the system.

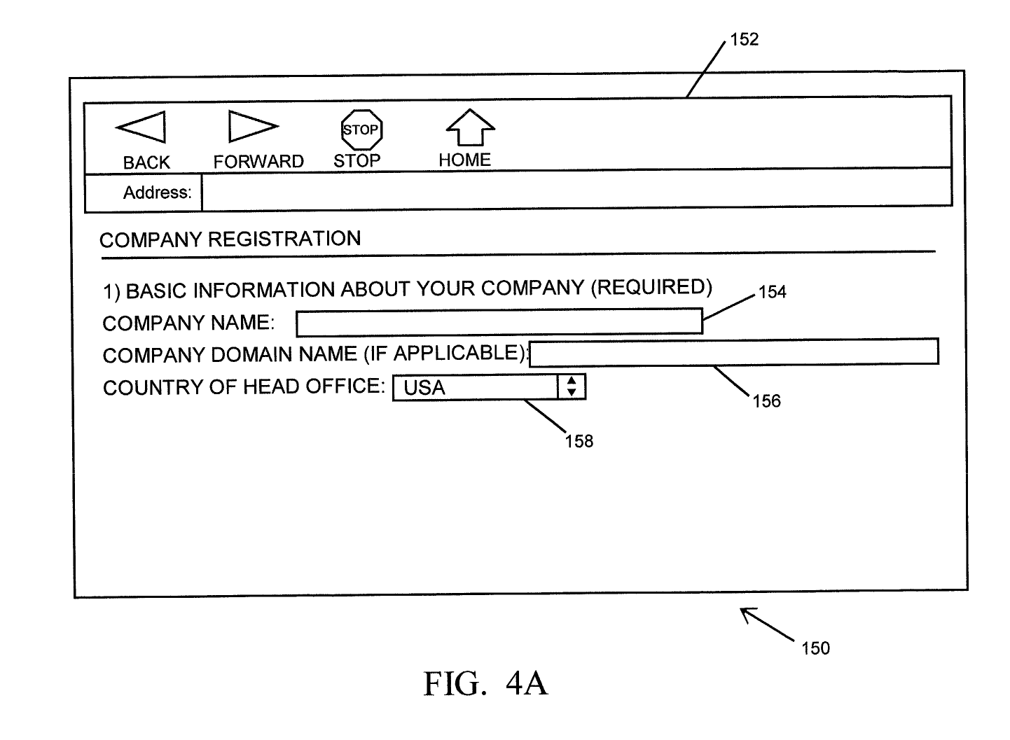

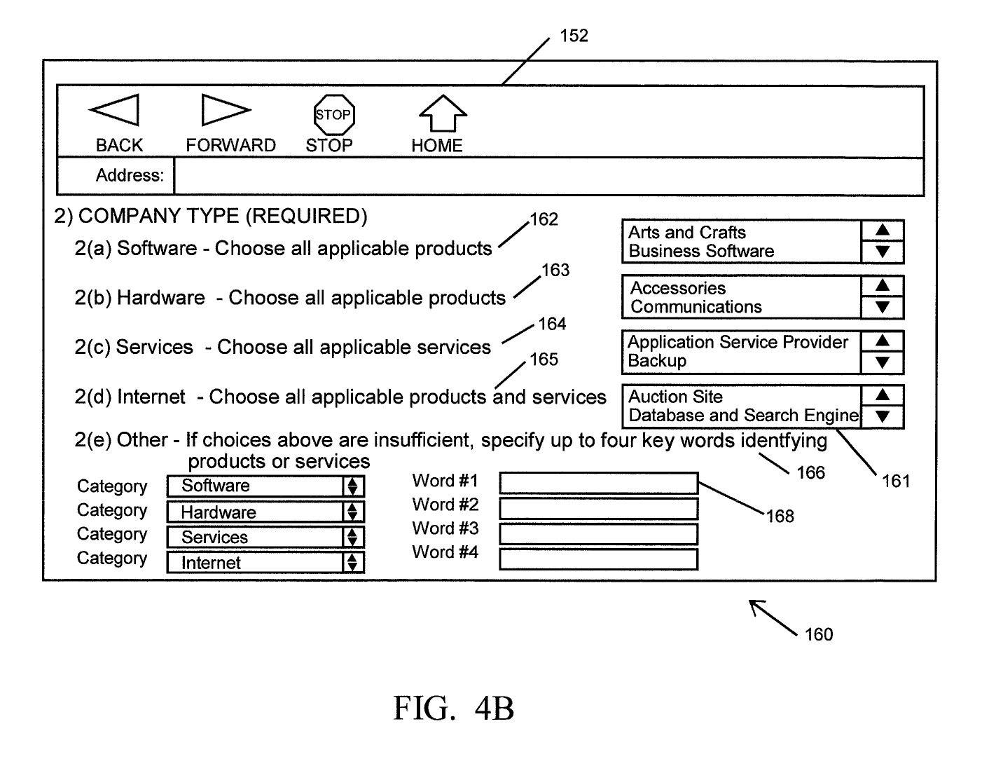

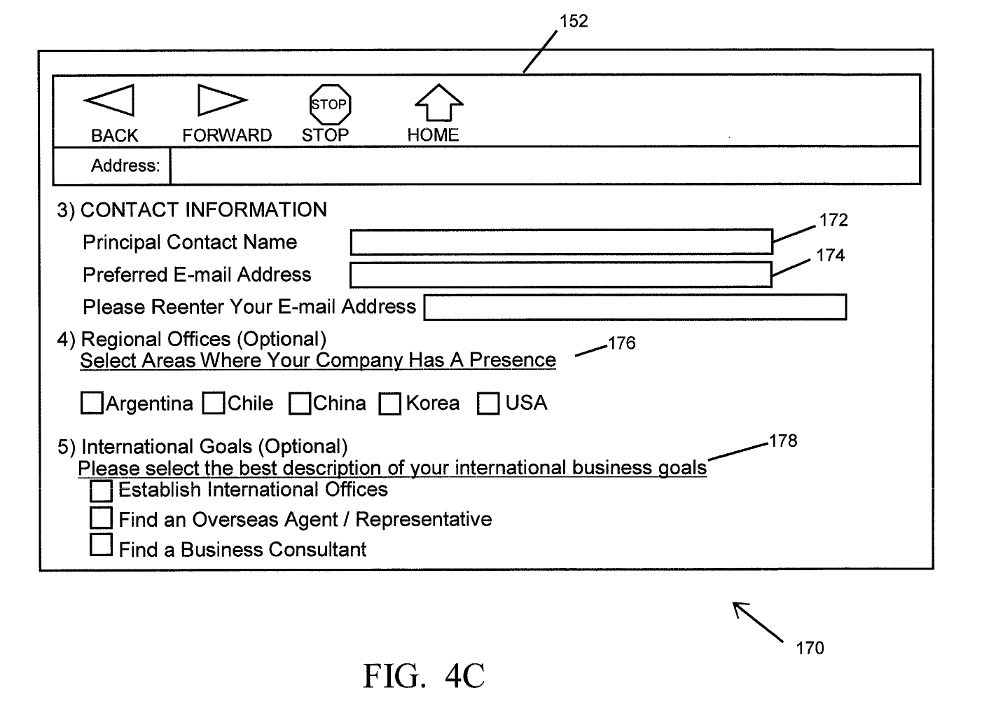

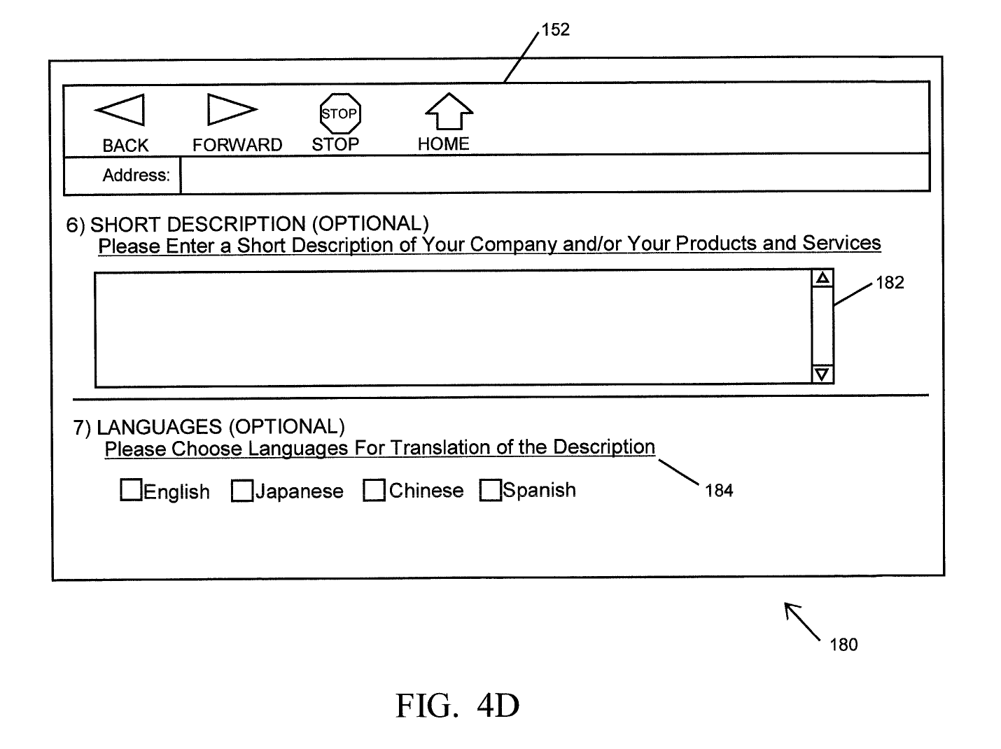

When the language of the registration has been selected 112, the registration module 94 produces the registration form. Typically, the registration form is displayed by a web browser on the registrant's data processing device 84. Exemplary English language registration forms 150, 160, 170, and 180 for the information technology industry are illustrated in FIGS. 4A-4D. Generally, the forms comprise a typical web browser navigation toolbar 152 and a combination of passive and active content. Passive content, such a heading for the registration form 150, is generated from data read from a resource file 114 included in the data base 92. Active content, such as the entries in pull down lists (for example list 161), is generated from data read from a display and translation table 98 included in the data base 92. Registration forms can be generated in each of the languages supported by the system. The data base includes appropriate resource files 104 for each of the supported languages. The appropriate English language, registration form resource file used to construct the registration forms 150, 160, 170, and 180 is selected when the registrant initiates registration 110 and selects the language of the registration 112.

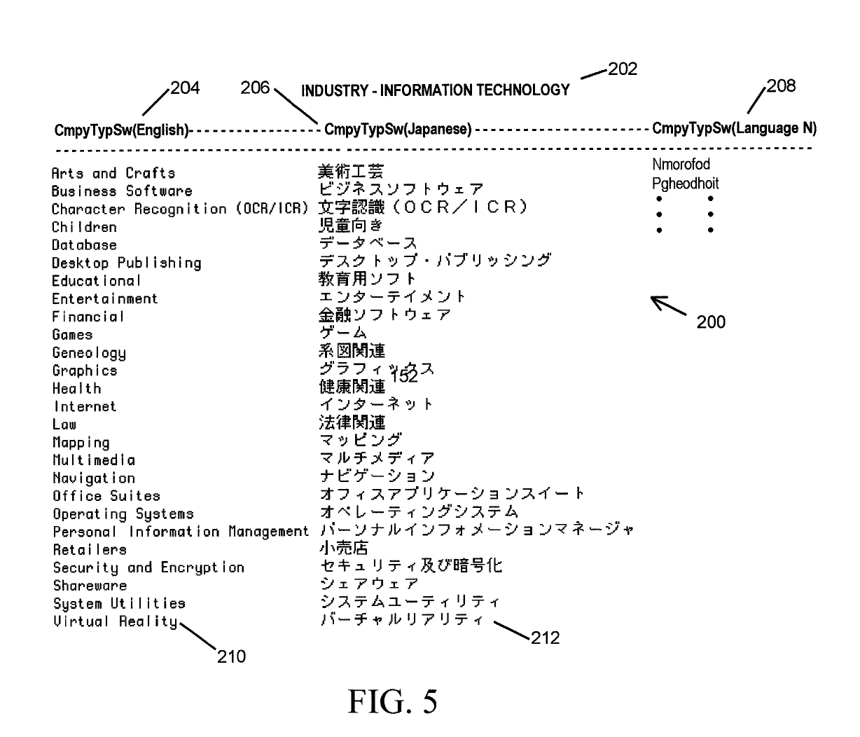

A display and translation table 98 comprises equivalent terms for each of the supported languages for each of a plurality of descriptors, for example a good or a service, used by the system to search for and identify the characteristics of entities registered with the system 80. A textual representation of an exemplary display and translation table 200 is illustrated in FIG. 5. Display and translation tables, such as table 200, are typically specific to an activity, such as an industry 202. The display and translation table 200 includes a column of descriptors, in this case terms describing goods or services related to the activity 202, for each natural language supported by system. As illustrated in FIG. 5, the display and translation table 200 includes a column of descriptors of products and services of the information technology industry 202 in English 204, Japanese 206, and language “N” 208. Each row of the display and translation table 200 contains an equivalent term for the descriptor in the terminology used in the industry for each natural language supported by the system. In other words, a translation of the English term “virtual reality” 210 as used by the information technology industry in Japan 212 and in each of the other supported natural languages is included in the display and translation table 200. The system 80 can be conveniently expanded to support an additional natural language by adding a new column of translated descriptors to the display and translation table 200. The registration module 102 selects the appropriate resource file 104 and the appropriate terms for the descriptors from the display and translation tables 98 to generate the registration form in the selected language of the registration.

The registration module 94 typically causes the registration form to be displayed on the registrant's data processing device 84 and accepts input from the registrant in the form of entries on the registration form 116. Information necessary to identify and communicate with the registrant such as an entity name 154, a domain name 156, and a location 158 is typically required. Referring to FIG. 4C, contact information including the name of the principal contact 172 for the entity and the contact's e-mail address 174 is typically required to facilitate communication with an entity such as business or other organization. The registration screen may also be used to gather additional information about the registering entity such as geographic areas of operation 176 and business goals 178. To facilitate searching the data base to identify registered entities having certain characteristics, such as businesses providing certain types of goods and services, and to improve the accuracy of the search results, the registrant describes the characteristics of the entity using descriptive terms known to the system as terms used in the industry. For example, FIG. 4B illustrates a registration screen for businesses engaged in an information technology industry. The goods and services of businesses engaged in the information technology industry have been divided into categories of products and services, including software 162, hardware 163, services 164, Internet 165, and other 166. Registration forms for other industries, such as real estate or financial services, would be similar but would categorize the products and services of the industry in a way appropriate to the industry. For each category appropriate to the registering entity's activities, the registrant chooses at least one term describing a characteristic (for example a good or service) associated with the registering entity. Since the terms displayed in the registration form 160 are the descriptors obtained from the appropriate display and translation table, the entity's characteristic is described in a term known to the system.

If none of the descriptors already included in the appropriate display and translation table 98 and displayed on the registration form are appropriate, the registrant can provide “other” keyword descriptors 166 for its products and services. When a new descriptor 168, such as a new product or service, is added to the system 80, the system treats the new descriptor as a request for optional services 126. The system writes a request for services to an auxiliary file 128 and e-mails a translator with experience with the terminology used by the appropriate activity for a translation of the new descriptor 136. For example, if the term “channel bank” was input by a registrant registering a business in the communications industry, e-mail would be sent to service providers familiar the communications industry seeking expert translations of “channel bank” in each of the supported natural languages. When a translation of a special descriptor is received by the system 80, the term is written to the appropriate display and translation table 132 so that the table contains an equivalent term in each of the natural languages supported by the system and the appropriate term in the natural language of the registering entity is written to the entity's data file.

The registrant can also provide a short description of the entity and associated characteristics, such as its products and services 182, as illustrated in FIG. 4D. In addition, the registrant may request the provision of other special services related to the registration. For example, the registrant may be request the translation of an advertisement prepared by the entity or the development and translation of an advertisement or multimedia presentation to be associated with the registering entity or its products and services. When a request for special services is received by the system 126, the request is written to an auxiliary file 128 and a request to provide the service is e-mailed to a translation service provider 130 registered with the system. The user may elect a machine translation of the specially requested message and the system 80 will transfer the auxiliary file to a machine translator for translation. When the advertisement, presentation, or special service is received by the system 80, it is associated with the registering entity's data file 132. The registration form 180 permits the registrant to elect one or more languages for translation of the special registrant description 184 or other special service.

When the registrant has completed the registration form, the registration module 94 reads the registrant's entries 116 and checks to determine if the data is valid 118. For example, if the registrant enters Kanji characters in the email address field, the system will notify the registrant of an error in the entry. If the data entered by the registrant is valid 118, the registration module 94 writes the registration data to an integration file 120. The integration engine 100 reads the integration file 122 for the registration data and generates a system identification 124. The integration engine 100 writes the data, including the registering entity's name or other identification and entity characteristics, to a registering entity record or data file 106 in the data base 92. The integration engine 100 and the registration module 94 sent e-mail to the contact 172 identified by the registrant advising the contact of the registered entity's system identification and system password 136. If there is an additional registration to process 138, the integration engine 100 reads the appropriate data file and generates another system identification 124. If not, the registration process is complete 140.

Registrants can update or modify the information in the registered entity's data file 106 through a modification module 96. Typically, the system requires that the registrant enter the appropriate system identification and password to access the appropriate entity's data file 106. The integration engine 100 typically reads the data from the entity's data file 106 and displays the entity's registration data as the default data in pull down menus or lists on the registration form 150. Through the update module, the registrant can alter the registration data stored in the entity's data file or request optional services available during initial registration and the system will processes the modification as if the data were being entered at the initial registration.

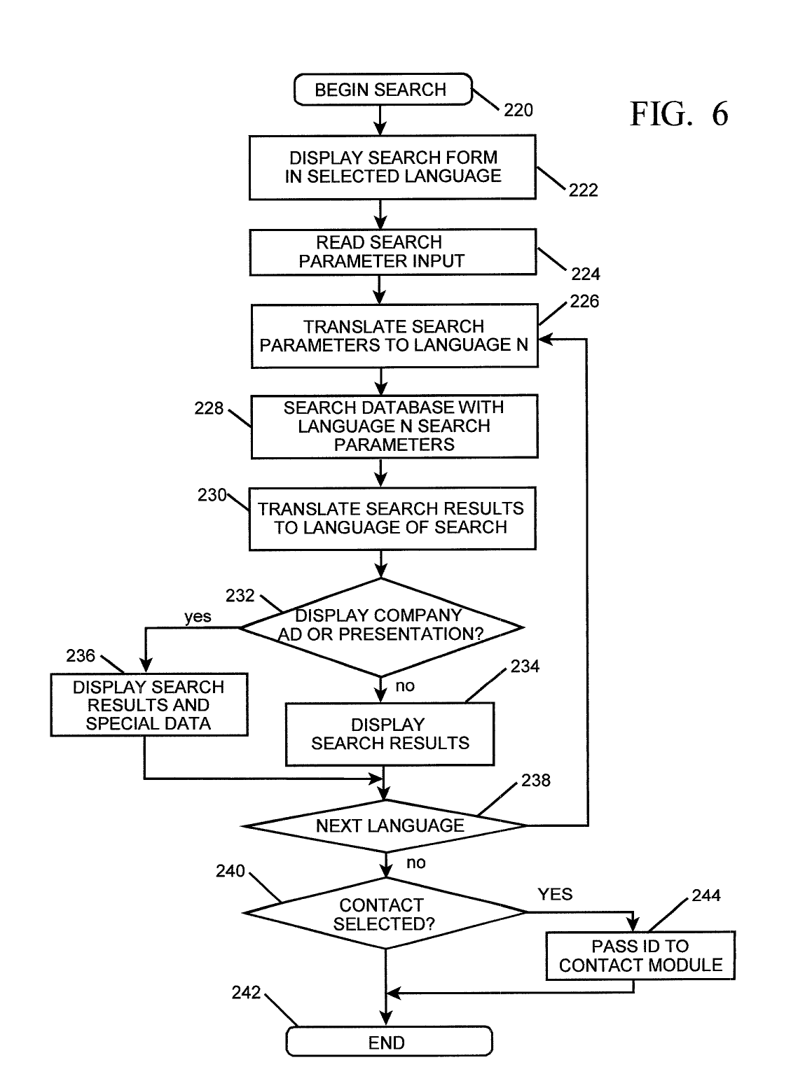

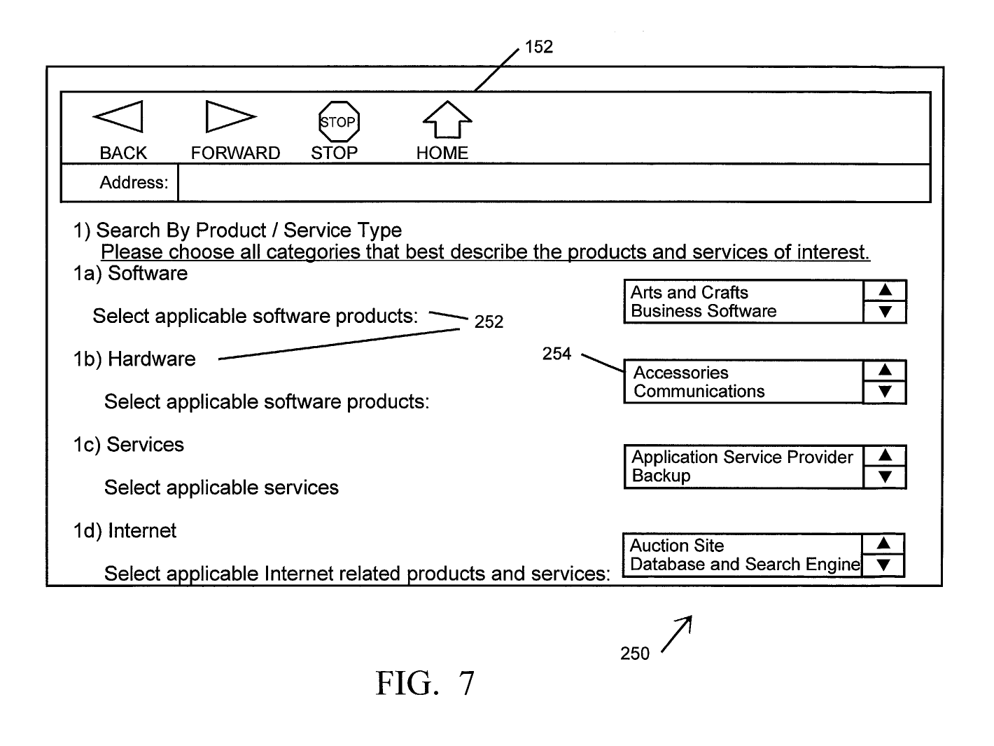

A user wishing to identify an entity having certain characteristics and registered with the system 80 can contact the system from a data processing device 86 through a network communication link 90 and the communication interface 82. Referring to FIG. 6, when a search is initiated 220, the system generates and displays a search form for a supported activity in a supported language chosen by the searcher 222. The language of the search is the supported language selected by the searcher. FIG. 7 illustrates an exemplary English language search form 250 for the information technology industry. The search form 250 is typically presented as a web page with a typical browser navigation tool bar 152. The search form 250 is generated by reading passive content, such as form headings 252 and other textual elements, from a resource file 104 containing the data in the selected natural language of the search. Active content, such as a descriptor included a pull down list 254, is obtained from a display and translation table 98 for the industry of interest. The terms used for the active content portions of the search form are the translated descriptors used to register resources with the system and obtained from the display and translation table. Search forms similar to the form 250 can be generated in the other languages supported by system from data in appropriate resource files 104 and descriptors obtained from an appropriate display and translation table 98.

The searcher inputs search parameters for the search engine 102 by selecting the desired active content (in this case, a description of a good or service) from the appropriate pull down list 254 of the search form 250. The search engine 102 selects a search term by selecting one of the equivalent translations of the selected search parameter from the appropriate display and translation table 98. For example, for a search in English the search engine 102 might choose the English language term for the search parameter designated in the pull down menu 254 as a first search term. The entities records or data files 106 of the data base 92 are searched for entities that have designated an entity characteristic (a good or service) in English matching the first search term.

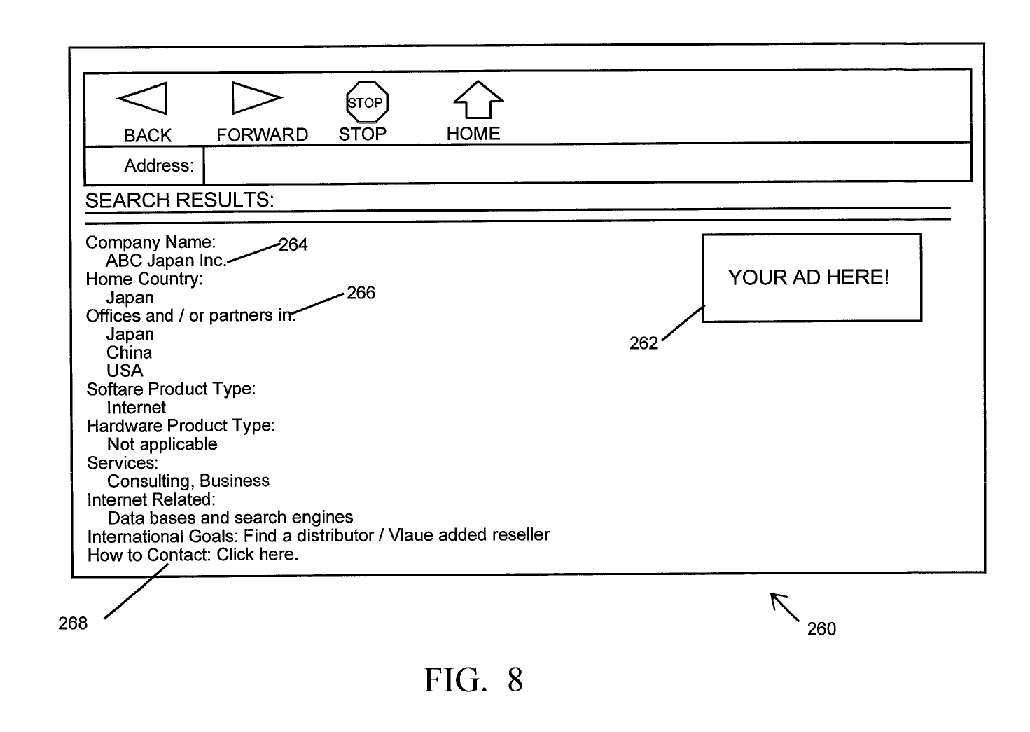

If an entity having the appropriate characteristic is identified by the search engine 102, the search engine 102 translates the data in the identified registered entity's data file 106 to the language selected for the search 230. The results of the search are then presented to the searcher 234 in language of the searcher. For example, FIG. 8 illustrates an exemplary display 260 in English of a result of a search that identified a Japanese company 264. The search result display is generated with passive content, such as subject headings 266, obtained from a resource file 104 for the natural language of the search and variable content obtained by selecting translations of the content of the identified registered entity's data file 106 from a display and translation table 98. If an identified registered entity has requested an optional advertisement, presentation, or other special service in the language of the search 232, the special service is displayed 262 or otherwise presented to the searcher with the search results. For example, the exemplary search result report 260 includes an advertisement 262 requested by the registered entity identified by the search. Advertisements or other presentations can be targeted to persons having specific interests and language capability.

When the search engine 102 has searched all registered entity data files 106 for characteristics equivalent to the search term in the first language, the search engine 102 obtains the equivalent search term for the next language 238 from the appropriate display and translation table 98. For example, referring again to FIG. 5, if the searcher is seeking companies providing virtual reality products 210 the search engine may initially search the entity records or data files 106 for entities listing the entity characteristic “virtual reality” in English. After searching the entity data files 106 for “virtual reality,” the search engine 102 obtains the term listed in the display and translation table as the equivalent term in Japanese 212 and compares this search term to registered entity characteristics in a next search of the registered entity records 106. Upon completion of the search in Japanese, the search engine 102 selects the equivalent term in a next supported language 238 to conduct another search of the registered entity data files 106. The process is repeated for all natural languages supported by the system.

The search result report 260, includes a hyperlink 268 permitting the searcher to elect to contact an entity of interest identified by the search. The search is concluded 242 when the searcher elects whether to contact the identified registrant 240. If the searcher elects to contact the registrant, the registered entity's identification is passed to the contact module 98 in anticipation of preparing a message to be sent to the entity's designated contact.

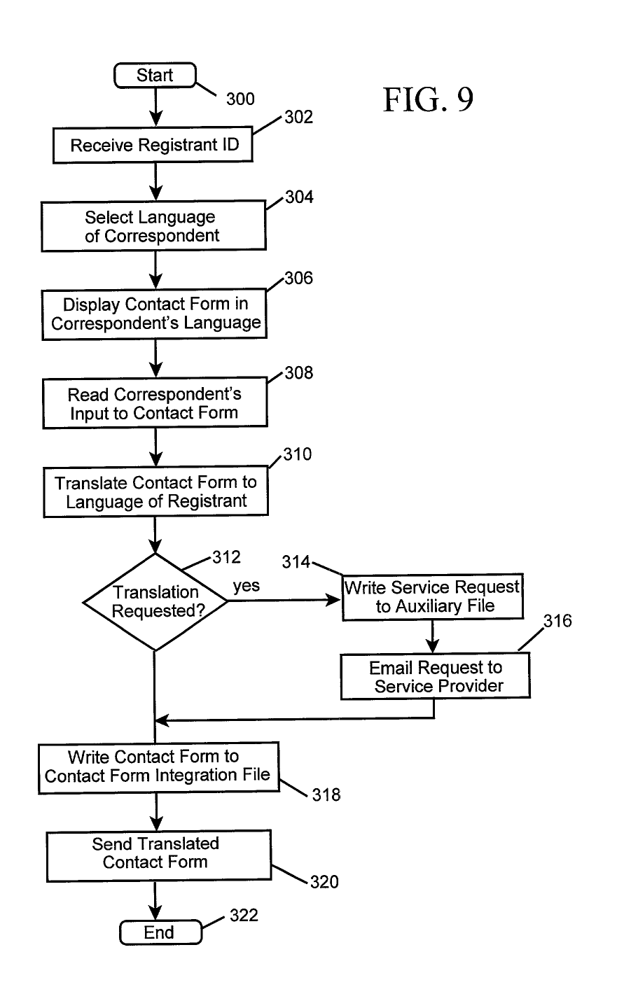

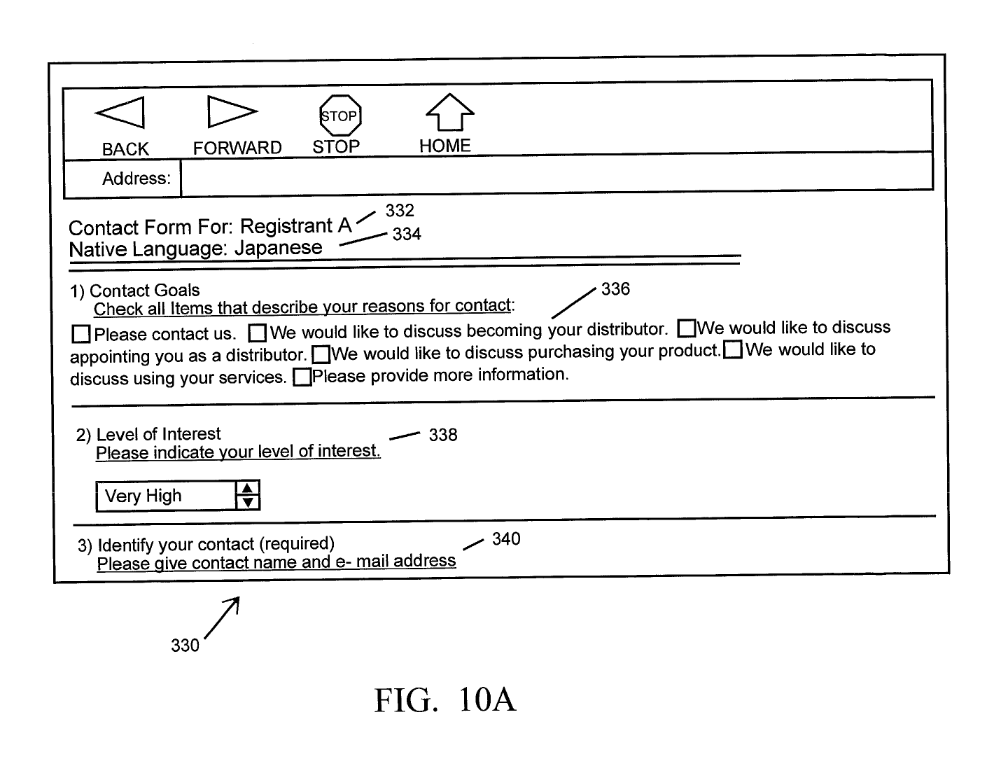

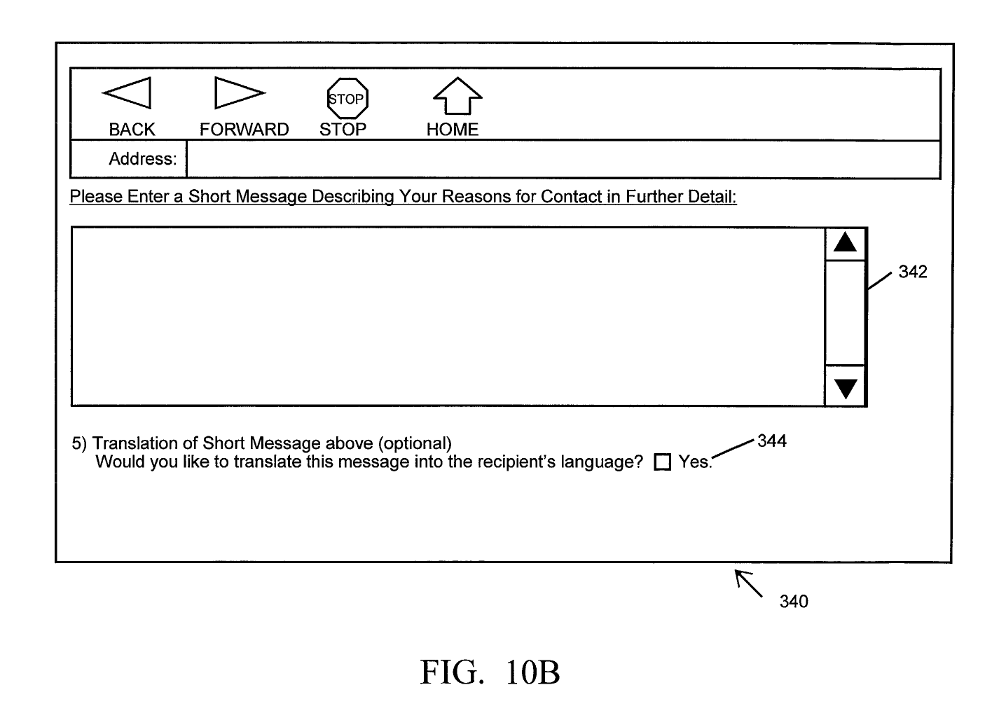

Referring to FIG. 9, when the contact process is initiated 300 by either selecting a registered entity identified during a search or otherwise, the identification of the entity is sent to the contact module 302. The language of the correspondent is identified 304. Typically, the language of the contact form defaults to the language used in a search, but the correspondent may select any supported natural language for the contact forms to be displayed by the system 80. The contact form is displayed in the correspondent's chosen language 306. An exemplary contact form 330 and 340 is illustrated in FIGS. 10A and 10B. Typically, the contact form 330 identifies the entity to receive the message 332 and the language used by the recipient 334 which is obtained from the registered entity's record or data file 106. The contact form 330 also includes a message section providing a number of pre-translated messages 336 which the correspondent can select with a mouse click. Translations of these messages 336 for each supported natural language are in stored resource files 104. The contact form 330 also affords the correspondent the opportunity to indicate a level of interest in the subject 338 and provides for identification of the correspondent's contact including an e-mail address 339. To further facilitate communication, the contact form 340 permits the correspondent to enter a short message 342 which can be translated 344 into the recipient's language, if desired. The contact form may also provide for access to other services related to the activities of senders and recipients. For example, a hyperlink or other means incorporated in the contact form can enable the correspondent to purchase products of interest from a company identified in a search or provide a mechanism for contacting a consultant familiar with international business activities related to the industry of interest.

When the correspondent has completed the contact form 330 and 340, the contact module 102 reads the correspondent's input to the form and translates the form to the language of the recipient 310. Generally, translation comprises selecting translated passive content for the message form and an appropriate translation of a selected pre-translated message 336 from a resource file 104 in the data base 92. If the correspondent has added a message 342 requiring translation 312, a service request to translate the message is written to an auxiliary file 314 and e-mailed to a service provider for translation 316. When the translation is received by the system 80, the translated message is written to a contact form integration file 318 and the translated contact form is e-mailed to the recipient 320 to complete the initial contact with the recipient 322. Upon receipt, a recipient using a data processing device 88 connected to the system 80 can invoke the contact module 98 of the system to respond to the original message.

The data processing system 80 of the present invention provides a language independent mechanism suited to identifying and communicating with businesses or other entities engaged in activities of interest throughout the world. A person seeking to locate a provider of a product or service can search the system using the seeker's own language. A business supplying the product or service of interest can be identified in the seeker's language even if that business is located in another country. Further, the system provides means to permit a correspondent to prepare a message in the correspondent's language that will be delivered to the recipient in the recipient language.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

The invention claimed is:

1. A method of locating an entity in a multilingual environment comprising the steps of:
(a) storing an entity identification and at least one entity characteristic in an entity record; said entity characteristic being a term in a first language;
(b) constructing a translation table including at least a first language term and a second language term for a descriptor;
(c) specifying said second language term for said descriptor as a search parameter; and
(d) searching said entity record for an entity characteristic corresponding to said search term.

2. The method of claim 1 wherein said at least one entity characteristic is at least one of a product and a service.

3. The method of claim 1 wherein at least one of said first language and said second language comprises a natural language.

4. The method of claim 1 wherein at least one of said first language and said second language comprises an activity related terminology of a natural language.

5. The method of claim 1 wherein the step of storing an entity identification and at least one entity characteristic in an entity record comprises the steps of:
(a) selecting said first language as a language of a registration;
(b) displaying a registration form in said first language;
(c) reading data identifying said entity and said at least one entity characteristic from said registration form; and
(d) storing said entity identification and said at least one entity characteristic in said entity record in said first language.

6. The method of claim 5 wherein said at least one entity characteristic is at least one of a product and a service.

7. The method of claim 5 wherein at least one of said first language and said second language comprises a natural language.

8. The method of claim 5 wherein at least one of said first language and said second language comprises an activity related terminology of a natural language.

9. The method of claim 5 wherein said step of displaying a registration form in said first language comprises the steps of:
(a) reading a first content of said registration form in said first language from a resource file;
(b) reading said first language term for said descriptor from said translation table; and
(c) displaying a registration form comprising said first content and first language term for said descriptor.

10. The method of claim 9 wherein at least one of said first language and said second language comprises a natural language.

11. The method of claim 9 wherein at least one of said first language and said second language comprises an activity related terminology of a natural language.

12. The method of claim 1 wherein the step of specifying said second language term for said descriptor as a search parameter comprises the steps of:
(a) selecting said second language as a language of a search;
(b) displaying a search form in said second language;
(c) displaying a second language term from said translation table for at least one descriptor; and
(d) selecting at least one said displayed descriptor as said search parameter.

13. The method of claim 12 wherein at least one of said first language and said second language comprises a natural language.

14. The method of claim 12 wherein at least one of said first language and said second language comprises a specialized terminology of a natural language.

15. The method of claim 1 wherein the step of searching said entity record for an entity characteristic corresponding to said search parameter comprises the steps of:
(a) comparing said search parameter to said entity characteristic included in said entity record;
(b) designating as said search parameter another term for said descriptor from said translation table; said another term for said descriptor being in another language; and
(c) repeating steps (a) and (b) for at least said another term for said descriptor in said first language.

16. The method of claim 15 wherein said at least one entity characteristic is at least one of a product and a service.

17. The method of claim 15 wherein at least one of said first language and said second language comprises a natural language.

18. The method of claim 15 wherein at least one of said first language and said second language comprises an activity related terminology of a natural language.

19. The method of claim 1 further comprising the step of reporting a result of said searching in said second language.

20. The method of claim 19 wherein the step of reporting a result of said searching in said second language comprises the steps of:
(a) reading a first content of a search result report in said second language from a resource file;
(b) reading said second language term for said descriptor from said translation table; and
(c) displaying said search result form comprising said first content and said second language term for said descriptor.

21. The method of claim 20 wherein at least one of said first language and said second language comprises a natural language.

22. The method of claim 20 wherein at least one of said first language and said second language comprises an activity related terminology of a natural language.

23. A method of communicating in a multilingual environment comprising the steps of:
(a) preparing a message in a native language of said communicant;
(b) selecting a language of said recipient;
(c) searching a database for a translation of said message in said language of said recipient; and
(d) transmitting said translation of said message to said recipient.

24. A method of locating an entity in a multilingual environment comprising the steps of:
(a) selecting a language of a registration;
(b) storing in a computer searchable entity record an identification of said entity and at least one entity characteristic in said registration language;
(c) constructing a translation table including at least a registration language term and a second language term for a descriptor;
(f) specifying said second language term for said descriptor as a search parameter; and
(g) searching said entity record for an entity characteristic corresponding to at least one of said second language term and said registration language term.

25. The method of claim 24 wherein said at least one entity characteristic is at least one of a product and a service.

26. The method of claim 24 wherein at least one of said registration language and said second language comprises a natural language.

27. The method of claim 24 wherein at least one of said registration language and said second language comprises an activity related terminology of a natural language.

28. The method of claim 24 wherein said entity characteristic is said registration language term for said descriptor.

29. A method of locating an entity in a multilingual environment comprising the steps of:
(a) selecting a language of a registration;
(b) storing in a computer searchable entity record an identification of said entity and at least one entity characteristic in said registration language;
(c) constructing a translation table including at least a registration language term and a second language term for a descriptor;
(d) specifying said second language term for said descriptor as a search parameter;
(e) searching said entity record for an entity characteristic corresponding to said second language term;
(f) selecting said registration language term for said descriptor as a search term; and
(g) searching said entity record for an entity characteristic corresponding to said search term.

30. A data processing system comprising:
(a) a registration module to record an identification of an entity and at least one entity characteristic in a computer searchable entity record, said entity characteristic being a term in a registration language;
(b) a computer searchable translation table including at least a term in said registration language and a term in a second language for a descriptor; and
(c) a search engine to accept a designation of said second language term for said descriptor as a search parameter and to search said entity record for a entity characteristic corresponding to said registration language term.

31. The system of claim 30 wherein at least one of said registration language and said second language comprises a natural language.

32. The system of claim 30 wherein at least one of said first language and said second language comprises an activity related terminology of a natural language.

33. The system of claim 30 wherein said registration module comprises:
(a) a first content of a registration form in said registration language stored in a computer readable resource file;
(b) a registration form generator to display a registration form on a data processing device; said registration form comprising said first content and said registration language term for at least one said descriptor;
(c) an input device to enable a registrant to input an identification of said entity and an entity characteristic to said registration form; and
(d) an integration engine to read said input to said registration form and store said identification of said entity and entity characteristic in said entity record.

34. The system of claim 33 wherein said input device enables said registrant to select a displayed registration language term for at least one descriptor as said entity characteristic.

35. The system of claim 33 wherein said integration engine further comprises a communication module to request and receive a translation of an entity characteristic read from said registration form.

36. The system of claim 30 wherein said search engine comprises:
(a) a first content of a search form in said second language stored in a computer readable resource file;
(b) a search form generator to display a search form on a data processing device; said search form comprising said first content and said second language term for at least one said descriptor;
(c) an input device to enable a searcher to select a displayed term for a descriptor as a search parameter;
(d) a search term selector to select said registration language term corresponding to said search parameter from said translation table; and
(e) a comparison engine to compare said search term to said entity characteristic of said entity record.

37. The system of claim 30 further comprising:
(a) a first language message file comprising a first language translation of a message;
(b) a second language message file comprising a second language translation of said message; and
(c) a communication module to transmit said first language translation from said first language message file in response to a user selection of said second language translation of said message.

38. The system of claim 30 further comprising a communication interface to a data processing network enabling communication between said system and a remote data processing device.

39. The system of claim 38 wherein at least one of said registration module, said translation table, and said search engine is installed on said remote data processing device.

40. The system of claim 32 wherein at least one of said registration module and said search engine comprises a document displayable on said remote data processing device.

41. A data processing system comprising:
(a) a communication interface enabling a remote data processing device to communicate with said system;
(b) a registration module, including a document displayable on said remote data processing device, enabling a user of said remote data processing device to select a registration language and input an identity of said entity and at least one entity characteristic, said entity characteristic being a term in said registration language;
(c) a searchable entity record storing said entity identification and said at least one entity characteristic;
(d) a translation table comprising at least one descriptor term in said registration language and at least one substantially equivalent descriptor term in a second language;
(e) a search engine, including a document displayable on said remote data processing device, to identify from said entity record an entity associated with said descriptor term in said registration language in response to designation of said descriptor term in said second language as a search parameter.

42. The system of claim 41 wherein said at least one entity characteristic is at least one of a product and a service.

43. The system of claim 41 wherein at least one of said registration language and said second language comprises a natural language.

44. The system of claim 41 wherein at least one of said registration language and said second language comprises an activity related terminology of a natural language.

45. The system of claim 41 further comprising an integration engine requesting at least one translation of a descriptor term in response to an input of an entity characteristic not matching a descriptor term in said translation table.
